(19) United States
(12) Patent Application Publication
(10) Pub. No.: US 2024/0402640 A1
(43) Pub. Date: Dec. 5, 2024

(54) IMAGE FORMING APPARATUS, PROVIDING METHOD, AND NON-TRANSITORY COMPUTER-READABLE RECORDING MEDIUM

(71) Applicant: Konica Minolta, Inc., Tokyo (JP)

(72) Inventor: Naoki MIYAGAWA, Toyokawa-shi (JP)

(21) Appl. No.: 18/638,222

(22) Filed: Apr. 17, 2024

(30) Foreign Application Priority Data
Jun. 2, 2023 (JP) 2023-091628

(51) Int. Cl. G03G 15/00

(52) U.S. Cl. CPC G03G 15/55; G03G 15/5016

(57) ABSTRACT

An image forming apparatus includes a hardware processor. The hardware processor specifies a target component requiring maintenance, among one or more components of the image forming apparatus. The image forming apparatus further includes a display that displays access information for accessing maintenance information on the target component. The access information is information readable by an external terminal different from the image forming apparatus.

### CROSS REFERENCE TO RELATED APPLICATIONS

The entire disclosure of Japanese Patent Application No. 2023-091628, filed on Jun. 2, 2023, is incorporated herein by reference in its entirety.

### BACKGROUND OF THE INVENTION

### Technical Field

The present disclosure relates to an image forming apparatus, a providing method for providing maintenance information on the image forming apparatus, and a non-transitory computer-readable recording medium storing a program that causes a computer to perform the providing method.

### Description of Related Art

Methods for providing maintenance information indicating a maintenance procedure for an image forming apparatus have been proposed. Japanese Laid-Open Patent Publication No. 2008-282217 (Patent Literature 1) discloses a system for displaying maintenance information on a mobile terminal by reading, with the mobile terminal, QR Codes® affixed to various locations of an image forming apparatus.

Japanese Laid-Open Patent Publication No. 2011-48015 (Patent Literature 2) discloses that a power source mode is changed and a replacement procedure is displayed on a display of an image forming apparatus when a component is to be replaced.

Japanese Laid-Open Patent Publication No. 2007-86944 (Patent Literature 3) discloses that a mobile terminal acquires a status of a printer from the printer by means of infrared communication or the like, and an operation procedure depending on the status is displayed on the mobile terminal.

### SUMMARY OF THE INVENTION

In the case of the method disclosed in Patent Literature 1, maintenance information cannot be provided, for a location to which the QR code cannot be affixed. Moreover, in the case of the method disclosed in Patent Literature 1, if the QR code gets dirty or damaged in a process in which the image forming apparatus is used, the QR code cannot be read and an operator who performs maintenance cannot acquire the maintenance information.

In the case of the method disclosed in Patent Literature 2, if a site to be subjected to maintenance is located away from the display of the image forming apparatus, performing maintenance while watching the display is inconvenient for an operator who performs the maintenance.

In the case of the method disclosed in Patent Literature 3, settings for connecting the mobile phone to the printer are necessary. Therefore, in many cases, only a specific user among users of the image forming apparatus makes the settings, and thus the user who can acquire maintenance information is limited. Moreover, in the case of the method disclosed in Patent Literature 3, when a serviceperson performs maintenance, it is necessary to connect a mobile terminal of the serviceperson to a printer of a customer. However, the customer may reject the connection between the mobile terminal of the serviceperson and the printer, for security concerns.

One object of the present disclosure is to mitigate inconvenience for an operator who performs maintenance, and prevent the operator who can acquire maintenance information from being limited to a specific operator.

To achieve at least one of the abovementioned objects, according to an aspect of the present invention, an image forming apparatus reflecting one aspect of the present invention comprises a hardware processor. The hardware processor specifies a target component requiring maintenance, among one or more components of the image forming apparatus. The image forming apparatus further comprises a display that displays access information for accessing maintenance information on the target component. The access information is information readable by an external terminal different from the image forming apparatus.

To achieve at least one of the abovementioned objects, according to an aspect of the present invention, a providing method for providing maintenance information on an image forming apparatus, reflecting one aspect of the present invention, comprises: specifying a target component requiring maintenance, among one or more components of the image forming apparatus; and displaying access information for accessing the maintenance information on the target component. The access information is information readable by an external terminal different from the image forming apparatus.

To achieve at least one of the abovementioned objects, according to an aspect of the present invention, a non-transitory computer-readable recording medium, reflecting one aspect of the present invention, is a non-transitory computer-readable recording medium storing a program that causes a computer to perform a providing method for providing maintenance information on an image forming apparatus. The providing method comprises: specifying a target component requiring maintenance, among one or more components of the image forming apparatus; and displaying access information for accessing the maintenance information on the target component. The access information is information readable by an external terminal different from the image forming apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating an example of an image forming apparatus according to the present embodiment.

FIG. 2 is a diagram illustrating an example of a hardware configuration of the image forming apparatus according to the present embodiment.

FIG. 3 is a diagram showing an example of a table according to the present embodiment.

FIG. 4 is a diagram illustrating an overview of a process in the image forming apparatus according to the present embodiment.

FIG. 5 is a diagram illustrating an example of a screen displayed on a display of the image forming apparatus according to the present embodiment.

FIG. 6 is a flowchart illustrating a procedure of a display process for displaying access information by the image forming apparatus according to the present embodiment.

FIG. 7 is a flowchart illustrating a part of a process procedure of a subroutine of step S1 according to the present embodiment.

FIG. 8 is a flowchart illustrating the remaining part of the process procedure of the subroutine of step S1 according to the present embodiment.

FIG. 9 is a flowchart illustrating a procedure of an update process for updating access information according to the present embodiment.

FIG. 10 is a diagram illustrating Modification Example 1 of the screen displayed on the display 52 of the image forming apparatus 100.

FIG. 11 is a diagram illustrating Modification Example 2 of the screen displayed on the display 52 of the image forming apparatus 100.

FIG. 12 is a diagram illustrating Modification Example 3 of the screen displayed on the display 52 of the image forming apparatus 100.

### DETAILED DESCRIPTION

Hereinafter, one or more embodiments of the present invention will be described with reference to the drawings. However, the scope of the invention is not limited to the disclosed embodiments. In the following, embodiments and modification examples according to the present disclosure will be described with reference to the drawings. In the following description, the same parts and constituent elements are denoted by the same reference characters. They have the same name and they also have the same function. Therefore, a detailed description thereof is not herein repeated. Note that the embodiments and modification examples described below may selectively be combined as appropriate.

### Embodiments

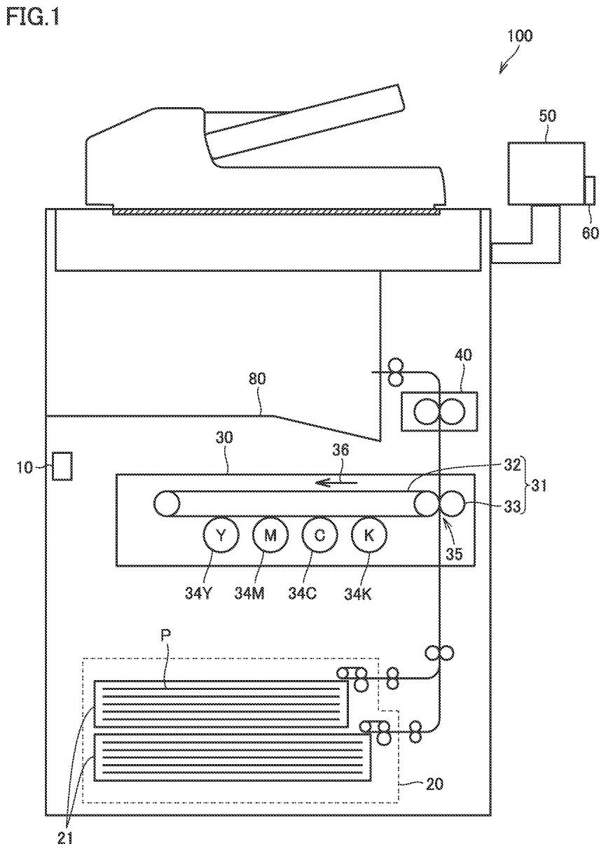

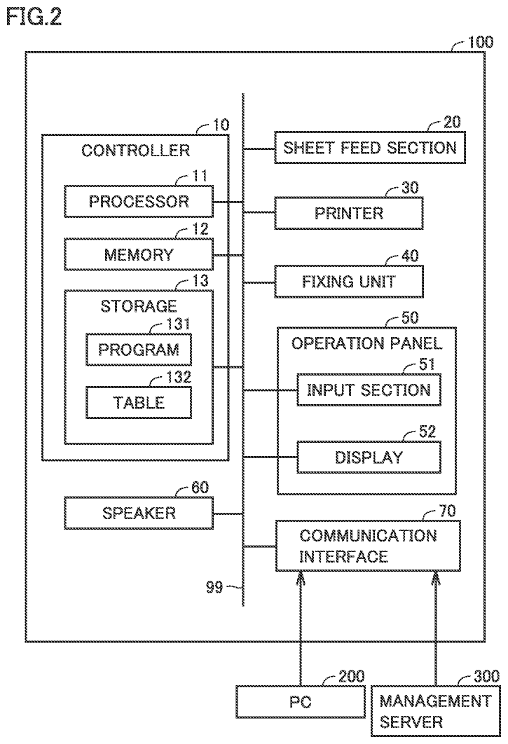

Referring to FIGS. 1 and 2, a configuration of an image forming apparatus according to the present embodiment will be described. FIG. 1 is a diagram illustrating an example of the image forming apparatus according to the present embodiment. FIG. 2 is a diagram illustrating an example of a hardware configuration of the image forming apparatus according to the present embodiment.

Referring to FIGS. 1 and 2, the image forming apparatus 100 forms an image on a sheet based on image data. In the following description, forming an image is also referred to as “printing.”

The image forming apparatus 100 includes a controller 10, a sheet feed section 20, a printer 30, a fixing unit 40, an operation panel 50, a speaker 60, and a communication interface 70. The controller 10, the sheet feed section 20, the printer 30, the fixing unit 40, the operation panel 50, the speaker 60, and the communication interface 70 are connected to each other via a bus 99.

The controller 10 includes a hardware processor (hereinafter simply referred to as a “processor”) 11, a memory 12, and a storage 13. The processor 11 is configured, for example, as a central processing unit (CPU) or a micro-processing unit (MPU), or the like. The memory 12 is configured, for example, as a volatile storage device such as a dynamic random access memory (DRAM) or a static random access memory (SRAM). The storage 13 is configured, for example, as a nonvolatile storage device such as a hard disk drive (HDD), a solid state drive (SSD), or a flash memory.

The storage 13 stores a program 131. The program 131 includes computer-readable instructions for controlling the image forming apparatus 100. The program 131 includes a program for causing a computer to perform a providing method for providing maintenance information on the image forming apparatus 100. The processor 11 executes the program 131 to control each component of the image forming apparatus 100 and implement various types of processes according to the present embodiment.

The program 131 may be provided as a part of an arbitrary program, rather than a single program. In this case, processes according to the present embodiment are implemented in cooperation with the arbitrary program. Such a program that does not include some of modules does not depart from the scope of the image forming apparatus 100 according to the present embodiment. A part or all of functions provided by the program 131 may be implemented by dedicated hardware.

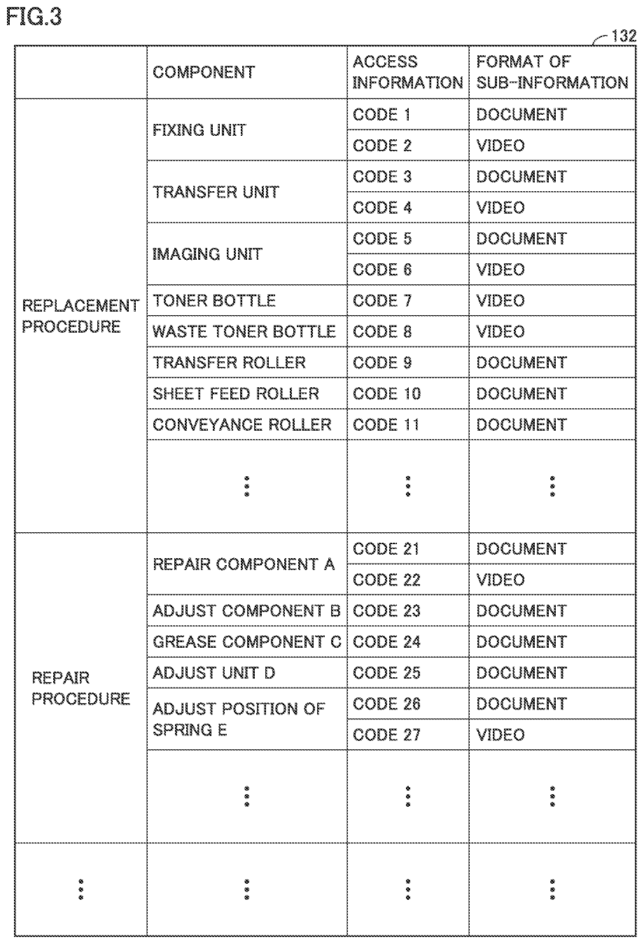

The storage 13 further stores a table 132. Here, the table 132 will be described with reference to FIG. 3. FIG. 3 is a diagram showing an example of the table according to the present embodiment. The table 132 includes access information for accessing maintenance information on the image forming apparatus 100.

The maintenance information indicates a maintenance procedure for the image forming apparatus 100. The maintenance includes at least one of replacement of a component and repair of a component. Repairing a component may include adjusting the component. Repairing a component may include an operation of applying grease to the component. The component includes at least one of a single component and a unit made up of a plurality of components.

The maintenance information is prepared in advance for each of one or more components that are to require maintenance, among a plurality of components of the image forming apparatus 100. The maintenance information on each component includes one or more pieces of sub-information. More specifically, the maintenance information on each component includes at least one of sub-information in a document format and sub-information in a video format. The sub-information in the document format is information indicating, in the document format, a maintenance procedure for the component. The sub-information in the video format is information indicating, in the video format, a maintenance procedure for the component.

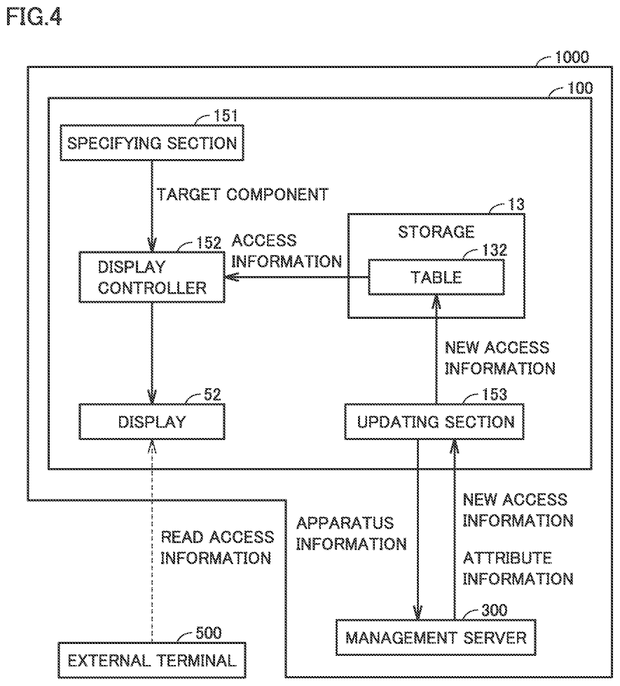

The access information is information readable by an external terminal 500 (see FIG. 4) different from the image forming apparatus 100. The external terminal 500 is a mobile terminal carried by an operator who performs maintenance. The operator who performs maintenance may be a user of the image forming apparatus 100 or a serviceperson who is in charge of repairing the image forming apparatus 100. The external terminal 500 is, for example, a smartphone. The external terminal 500 is, for example, a tablet.

The access information includes a two-dimensional code corresponding to respective one of the one or more pieces of sub-information. The two-dimensional code is, for example, a QR Code®. The two-dimensional code is, for example, Data Matrix®. The two-dimensional code represents a uniform resource locator (URL) of a web page on which the sub-information included in the maintenance information and corresponding to the two-dimensional code is posted.

In the example shown in FIG. 3, each of the maintenance information indicating a replacement procedure for a fixing unit, the maintenance information indicating a replacement procedure for a transfer unit, the maintenance information indicating a replacement procedure for an imaging unit, the maintenance information indicating a repair procedure for Component A, and the maintenance information indicating a procedure for adjusting the position of Spring E includes sub-information in the document format and sub-information in the video format. The maintenance information on each of the other components includes only one of sub-information in the document format and sub-information in the video format.

Referring again to FIGS. 1 and 2, the sheet feed section 20 feeds a sheet P to the printer 30. The sheet feed section 20 includes a sheet feed tray 21 for containing sheets P. The sheet P is, for example, paper.

The printer 30 uses toner to form a toner image (image) based on image data on a sheet P. The printer 30 includes a transfer unit 31, an imaging unit 34Y, an imaging unit 34M, an imaging unit 34C, and an imaging unit 34K. The transfer unit 31 includes a transfer belt 32 and a transfer roller 33. The transfer belt 32 is stretched over a plurality of rollers and moves in the direction of an arrow 36.

The imaging unit 34Y, the imaging unit 34M, the imaging unit 34C, and the imaging unit 34K are arranged in series along the direction in which the transfer belt 32 moves. The imaging unit 34Y forms a toner image in Y (yellow) on the transfer belt 32 based on image data. The imaging unit 34M forms a toner image in M (magenta) on the transfer belt 32 based on image data. The imaging unit 34C forms a toner image in C (cyan) on the transfer belt 32 based on image data. The imaging unit 34K forms a toner image in K (black) on the transfer belt 32 based on image data. The toner images in the respective colors are superimposed on transfer belt 32. When the sheet P passes through a nip portion 35 formed between the transfer belt 32 and the transfer roller 33, the toner image is transferred onto the sheet P to form an image on the sheet P.

The fixing unit 40 applies heat and pressure to the sheet P on which the image is formed, to fix the image on the sheet P. The sheet P on which the image is fixed is ejected to a sheet ejection tray 80.

The operation panel 50 includes an input section 51 and a display 52. The input section 51 receives a user operation, converts the operation into an operation signal, and outputs the operation signal to the processor 11. The input section 51 is, for example, a touch pad. The display 52 displays various kinds of information such as an operation status and a process result of the image forming apparatus 100. The display 52 is, for example, a liquid crystal display. In the operation panel 50, the input section 51 is arranged to overlap the display 52.

The speaker 60 outputs a sound such as a warning sound. Note that the image forming apparatus 100 may not include the speaker 60.

The communication interface 70 transmits and receives information to and from a personal computer (PC) 200. In one example, the processor 11 receives image data from the PC 200 via the communication interface 70.

The communication interface 70 transmits and receives information to and from a management server 300. In one example, the processor 11 transmits apparatus information to the management server 300 via the communication interface 70. In another example, the processor 11 receives new access information from the management server 300 via the communication interface 70. Details of the communication between the image forming apparatus 100 and the management server 300 will be described later herein.

Referring to FIGS. 4 to 9, a process in the image forming apparatus 100 according to the present embodiment will be described.

FIG. 4 is a diagram illustrating an overview of the process in the image forming apparatus according to the present embodiment. The image forming apparatus 100 includes a specifying section 151, a display controller 152, an updating section 153, the storage 13, and the display 52. The specifying section 151, the display controller 152, and the updating section 153 are implemented by the processor 11 executing the program 131. A providing system 1000 for providing maintenance information on the image forming apparatus 100 includes the image forming apparatus 100 and the management server 300.

The specifying section 151 specifies a target component requiring maintenance, among one or more components of the image forming apparatus 100.

The display controller 152 acquires, from the table 132, access information for accessing maintenance information on the target component specified by the specifying section 151. The display controller 152 causes the display 52 to display the access information. Thus, the display 52 displays the access information for accessing the maintenance information on the target component specified by the specifying section 151.

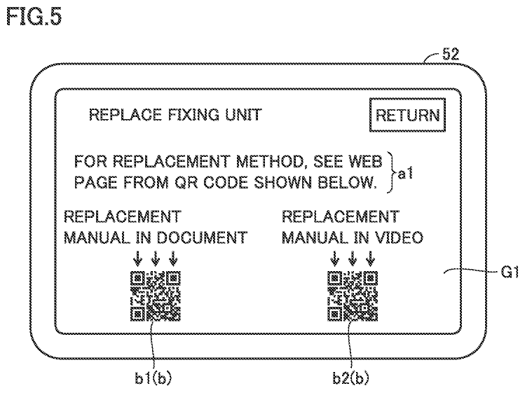

A screen displayed on the display 52 will be described with reference to FIG. 5. FIG. 5 is a diagram illustrating an example of the screen displayed on the display of the image forming apparatus according to the present embodiment. A screen G1 is an example of the screen displayed on the display 52 when a target component requiring maintenance is specified by the specifying section 151. In the example illustrated in FIG. 5, the fixing unit 40 has been specified by the specifying section 151 as a target component requiring maintenance.

As illustrated in FIG. 5, the display 52 displays a notification a1 to prompt browsing of a web page on which maintenance information is posted, and displays access information b. The access information b includes a QR code b1 and a QR code b2.

The QR code b1 is an example of “CODE 1” in FIG. 3. The QR code b1 is a code corresponding to sub-information indicating, in the document format, a procedure for replacing the fixing unit 40. More specifically, the QR code b1 represents a URL of a web page on which the sub-information is posted to indicate, in the document format, the procedure for replacing the fixing unit 40.

The QR code b2 is an example of “CODE 2” in FIG. 3. The QR code b2 is a code corresponding to sub-information indicating, in the video format, the procedure for replacing the fixing unit 40. More specifically, the QR code b2 represents a URL of a web page on which the sub-information is posted to indicate, in the video format, the procedure for replacing the fixing unit 40.

The notification a1 enables an operator who performs maintenance to know that the operator can view the maintenance information by reading at least one of the QR code b1 and the QR code b2, by means of the external terminal 500 that the operator carries.

Referring again to FIG. 4, the operator who performs maintenance reads the access information displayed on the display 52, by means of the external terminal 500 that the operator carries. More specifically, the operator who performs maintenance reads the two-dimensional code displayed on the display 52, by means of the external terminal 500 that the operator carries. When the two-dimensional code is read by the external terminal 500, sub-information included in the maintenance information and corresponding to the two-dimensional code is displayed on the external terminal 500.

Referring again to FIG. 5, when the operator who performs maintenance reads the QR code b1 by means of the external terminal 500 that the operator carries, the sub-information indicating, in the document format, the procedure for replacing the fixing unit 40 is displayed on the external terminal 500. When the operator who performs maintenance reads the QR code b2 by means of the external terminal 500 that the operator carries, the sub-information indicating, in the video format, the procedure for replacing the fixing unit 40 is displayed on the external terminal 500. Referring again to FIG. 4, the management server 300 is provided by the manufacturer of the image forming apparatus 100. The management server 300 manages maintenance information on various models of image forming apparatuses manufactured by the manufacturer of the image forming apparatus 100. The management server 300 manages at least maintenance information on the image forming apparatus 100.

Every time the maintenance information is updated, the management server 300 manages the updated maintenance information as the latest maintenance information. The management server 300 stores the latest maintenance information, reference information, and attribute information indicating an attribute of access information. The reference information includes at least one of identifying information on an image forming apparatus for which access information needs to be updated and identifying information on a component for which access information needs to be updated. The identifying information on the image forming apparatus includes at least one of the manufacturing number of the image forming apparatus, the model name of the image forming apparatus, and the version of the image forming apparatus. The identifying information on the component includes at least one of the lot number of the component and the serial number of the component.

The attribute information includes information indicating which component is associated with the maintenance information corresponding to the access information, and information indicating the format of the maintenance information corresponding to the access information. The information indicating which component is associated with the maintenance information corresponding to the access information includes at least one of the name of the component, the serial number of the component, and the lot number of the component. The format of the maintenance information includes at least one of the document format and the video format.

When maintenance information on a certain component of a certain image forming apparatus is updated, the management server 300 transmits an instruction to transmit apparatus information to one or more image forming apparatuses to be managed. The one or more image forming apparatuses to be managed include the image forming apparatus 100. The apparatus information includes at least one of identifying information on the image forming apparatus and identifying information on one or more components of the image forming apparatus.

When the updating section 153 receives, from the management server 300, the instruction to transmit the apparatus information, the updating section 153 transmits the apparatus information on the image forming apparatus 100 to the management server 300. The apparatus information on the image forming apparatus 100 includes at least one of identifying information on the image forming apparatus 100 and identifying information on one or more components of the image forming apparatus 100. The identifying information on the image forming apparatus 100 includes at least one of the manufacturing number of the image forming apparatus 100, the model name of the image forming apparatus 100, and the version of the image forming apparatus 100. The identifying information on one or more components of the image forming apparatus 100 includes at least one of the lot number of one or more components of the image forming apparatus 100 and the serial number of one or more components of the image forming apparatus 100.

Upon receiving the apparatus information from each of one or more image forming apparatuses to be managed, the management server 300 determines, based on the apparatus information and the above-described reference information, whether or not the access information stored in the image forming apparatus needs to be updated. In one example, when the identifying information on the image forming apparatus matches any of the identifying information included in the reference information, the management server 300 determines that the access information stored in the image forming apparatus needs to be updated. In another example, when at least one piece of identifying information among respective pieces of identifying information on one or more components of the image forming apparatus matches any of respective pieces of identifying information included in the reference information, the management server 300 determines that the access information stored in the image forming apparatus needs to be updated. In still another example, when the identifying information on the image forming apparatus matches any of respective pieces of identifying information included in the reference information and at least one piece of identifying information among respective pieces of identifying information on one or more components of the image forming apparatus matches any of respective pieces of identifying information included in the reference information, the management server 300 determines that the access information stored in the image forming apparatus needs to be updated.

When the access information stored in the image forming apparatus needs to be updated, the management server 300 transmits, to the image forming apparatus, new access information for accessing the latest maintenance information and attribute information indicating an attribute of the new access information.

In one example, when the access information stored in the image forming apparatus 100 needs to be updated, the management server 300 transmits, to the image forming apparatus 100, new access information for accessing the latest maintenance information and attribute information indicating an attribute of the new access information.

The updating section 153 acquires the new access information and the attribute information from the management server 300. The updating section 153 updates, based on the attribute information, the existing access information stored in the storage 13 to the new access information.

In one example, when the maintenance information corresponding to the new access information is maintenance information on the fixing unit 40 and the attribute information indicates that the format of the maintenance information corresponding to the new access information is the video format, the updating section 153 replaces “CODE 2” included in the table 132 illustrated in FIG. 3 with the new access information received from the management server 300.

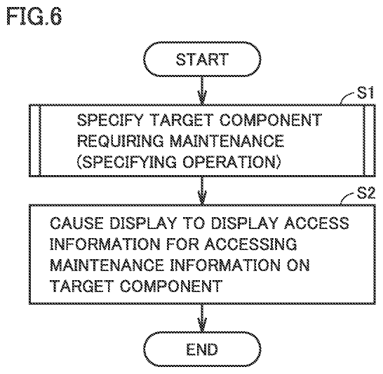

FIG. 6 is a flowchart illustrating a procedure of a display process for displaying access information by the image forming apparatus according to the present embodiment.

In step S1, the processor 11 specifies a target component requiring maintenance, among one or more components of the image forming apparatus 100. In the following description, the operation in step S1 is referred to as “specifying operation.”

In step S2, the processor 11 causes the display 52 to display access information for accessing maintenance information on the target component. After step S2, the display process ends.

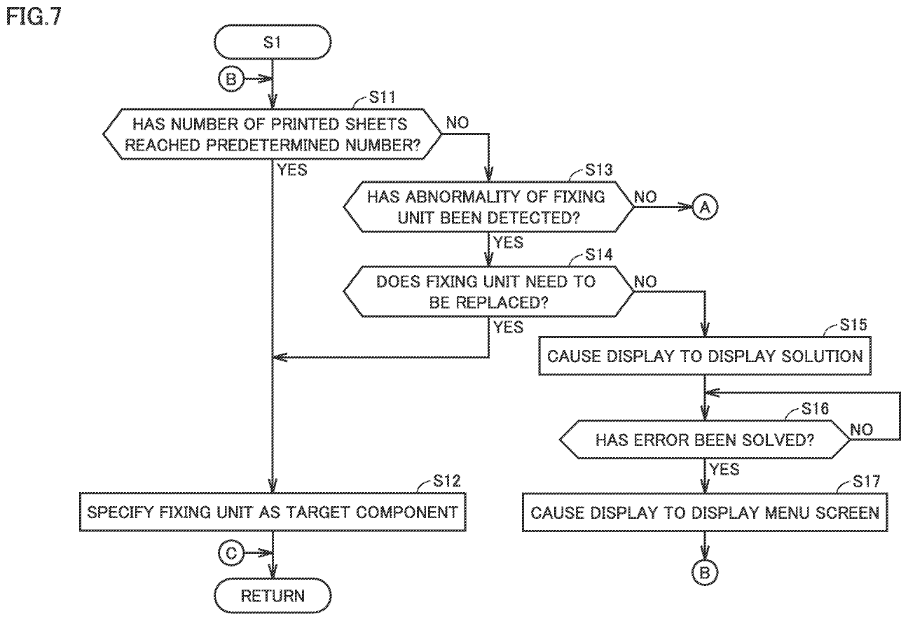

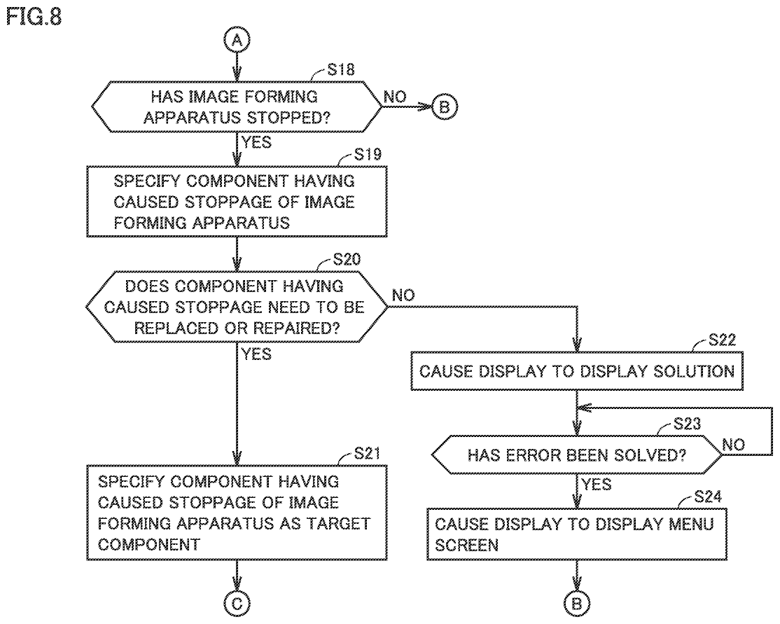

FIG. 7 is a flowchart illustrating a part of a process procedure of a subroutine of step S1 according to the present embodiment. FIG. 8 is a flowchart illustrating the remaining part of the process procedure of the subroutine of step S1 according to the present embodiment.

Referring to FIG. 7, in step S11, the processor 11 determines whether or not the number of printed sheets has reached a predetermined number of sheets. When the number of printed sheets has reached the predetermined number of sheets (YES in step S11), the processor 11 causes the process to proceed to step S12. When the number of printed sheets has not reached the predetermined number of sheets (NO in step S11), the processor 11 causes the process to proceed to step S13.

In step S12, the processor 11 specifies the fixing unit 40 as a target component requiring maintenance. After step S12, the operation of step S1, namely the specifying operation ends, and the processor 11 causes the process to proceed to step S2.

In step S13, the processor 11 determines whether or not an abnormality of the fixing unit 40 has been detected. In one example, when the image forming apparatus 100 is stopped during the fixing process by the fixing unit 40, the processor 11 determines that an abnormality of the fixing unit 40 has been detected. When an abnormality of the fixing unit 40 has been detected (YES in step S13), the processor 11 causes the process to proceed to step S14. When no abnormality of the fixing unit 40 has been detected (NO in step S13), the processor 11 cause the process to proceed to step S18.

In step S14, the processor 11 determines whether or not the fixing unit 40 needs to be replaced. In one example, when a sheet is jammed, the processor 11 determines that the fixing unit 40 does not need to be replaced. When the fixing unit 40 needs to be replaced (YES in step S14), the processor 11 causes the process to proceed to step S12. When the fixing unit 40 does not need to be replaced (NO in step S14), the processor 11 causes the process to proceed to step S15.

In step S15, the processor 11 causes the display 52 to display a solution for solving the abnormality of the fixing unit 40. In one example, the processor 11 causes the display 52 to display a notification to prompt removal of the sheet.

In step S16, the processor 11 determines whether or not the error has been solved. In one example, when the sheet has been removed, the processor 11 determines that the error has been solved. When the error has been solved (YES in step S16), the processor 11 causes the process to proceed to step S17. When the error has not been solved (NO in step S16), the processor 11 repeats step S16.

In step S17, the processor 11 causes the display 52 to display a menu screen. The menu screen includes a list of functions that the image forming apparatus 100 has. When using the image forming apparatus 100, a user selects a function that the user wants to use, from the menu screen. After step S17, the processor 11 causes the process to return to step S11.

Referring to FIG. 8, in step S18, the processor 11 determines whether or not the image forming apparatus 100 has stopped. When the image forming apparatus 100 has stopped (YES in step S18), the processor 11 causes the process to proceed to step S19. When the image forming apparatus 100 has not stopped (NO in step S18), the processor 11 causes the process to return to step S11.

In step S19, the processor 11 specifies the component that has caused the stoppage of the image forming apparatus 100.

In step S20, the processor 11 determines whether or not replacement or repair of the component that has caused the stoppage of the image forming apparatus 100 is necessary. In one example, when a sheet is jammed, the processor 11 determines that none of replacement and repair of the component that has caused the stoppage of the image forming apparatus 100 is necessary. When replacement or repair of the component that has caused the stoppage of the image forming apparatus 100 is necessary (YES in step S20), the processor 11 causes the process to proceed to step S21. When replacement or repair of the component that has caused the stoppage of the image forming apparatus 100 is not necessary (NO in step S20), the processor 11 causes the process to proceed to step S22.

In step S21, the processor 11 specifies the component that has caused the stoppage of the image forming apparatus 100, as a target component requiring maintenance. After step S21, the operation in step S1, namely the specifying operation ends, and the processor 11 causes the process to proceed to step S2.

In step S22, the processor 11 causes the display 52 to display a solution for solving the error state, that is, the state in which the image forming apparatus 100 is stopped. In one example, the processor 11 causes the display 52 to display a notification to prompt removal of the sheet.

In step S23, the processor 11 determines whether or not the error has been solved. In one example, when the sheet has been removed, the processor 11 determines that the error has been solved. When the error has been solved (YES in step S23), the processor 11 causes the process to proceed to step S24. When the error has not been solved (NO in step S23), the processor 11 repeats step S23.

In step S24, the processor 11 causes the display 52 to display a menu screen. After step S24, the processor 11 causes the process to return to step S11.

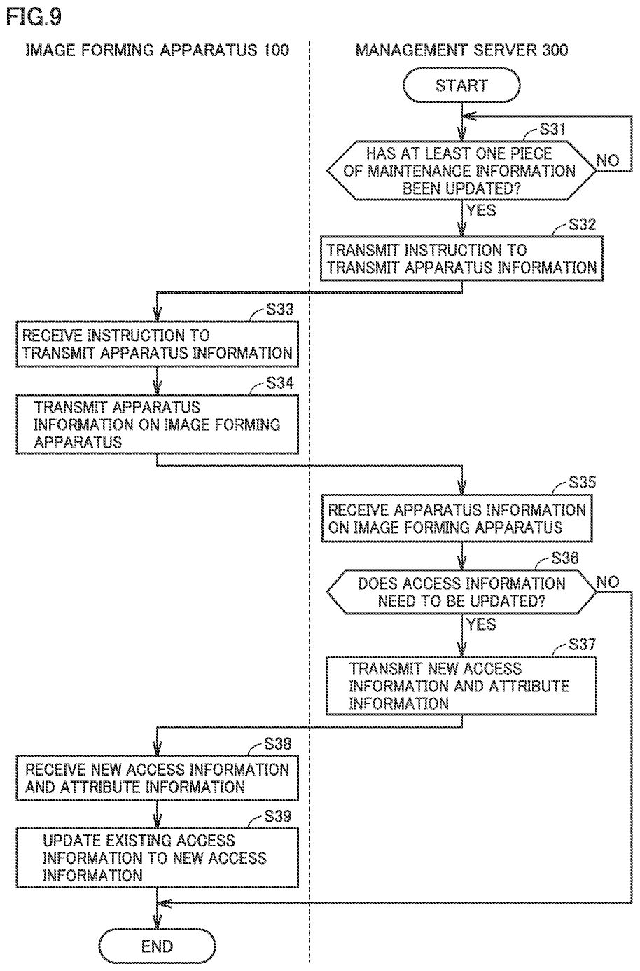

FIG. 9 is a flowchart illustrating a procedure of an update process for updating access information according to the present embodiment.

In step S31, the management server 300 determines whether or not at least one of a plurality of pieces of maintenance information has been updated. When at least one piece of maintenance information has been updated (YES in step S31), the processor 11 causes the process to proceed to step S32. When no maintenance information has been updated (NO in step S31), the processor 11 repeats step S31.

In step S32, the management server 300 transmits an instruction to transmit apparatus information to one or more image forming apparatuses to be managed.

In step S33, the processor 11 of the image forming apparatus 100 receives, from the management server 300, the instruction to transmit the apparatus information.

In step S34, the processor 11 transmits the apparatus information on the image forming apparatus 100.

In step S35, the management server 300 receives the apparatus information on the image forming apparatus 100.

In step S36, the management server 300 determines, based on the apparatus information on the image forming apparatus 100 and the above-described reference information, whether or not the access information stored in the image forming apparatus 100 needs to be updated.

When the access information stored in the image forming apparatus 100 needs to be updated (YES in step S36), the processor 11 causes the process to proceed to step S37. When the access information stored in the image forming apparatus 100 does not need to be updated (NO in step S36), the update process ends.

In step S37, the management server 300 transmits, to the image forming apparatus 100, new access information for accessing the latest maintenance information and attribute information indicating an attribute of the new access information.

In step S38, the processor 11 receives the new access information and the attribute information from the management server 300.

In step S39, the processor 11 updates, based on the attribute information, the existing access information stored in the storage 13 to the new access information. After step S39, the update process ends.

As described above, the image forming apparatus 100 according to the present embodiment specifies a target component requiring maintenance, and displays access information for accessing maintenance information on the target component. The access information is information readable by the external terminal 500 different from the image forming apparatus 100. Therefore, an operator who performs maintenance can view the maintenance information on the target component by reading the access information by means of the external terminal 500 that the operator carries. The operator can perform maintenance while watching the maintenance information displayed on the external terminal 500. Thus, even when a site to be subjected to maintenance is located away from the display 52, the operator can confirm the maintenance information at hand. Therefore, the image forming apparatus 100 according to the present embodiment can mitigate inconvenience for an operator who performs maintenance.

Moreover, according to the present embodiment, it is unnecessary to connect the external terminal 500 and the image forming apparatus 100 to each other. Therefore, the image forming apparatus 100 according to the present embodiment can prevent the operator who can acquire the maintenance information from being limited to a specific operator.

Moreover, the access information is displayed on the display 52 of the image forming apparatus 100, and therefore, the access information will not get dirty or damaged. Therefore, the external terminal 500 is prevented from failing in reading the access information. Therefore, with the image forming apparatus 100 according to the present embodiment, it is ensured that an operator who performs maintenance acquires the maintenance information.

### Modification Example 1

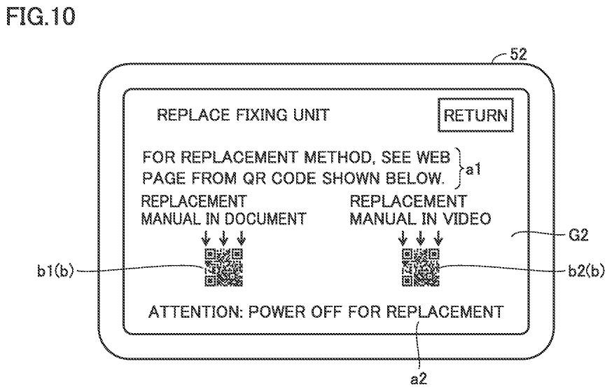

FIG. 10 is a diagram showing Modification Example 1 of the screen displayed on the display 52 of the image forming apparatus 100. When a target component requiring maintenance is specified by the specifying section 151, the display 52 may display the screen G1 (see FIG. 5), regardless of whether it is necessary to power off the image forming apparatus 100 for maintenance of the target component. However, when a target component requiring maintenance is specified by the specifying section 151 and the image forming apparatus 100 needs to be powered off for maintenance of the target component, the display 52 may display a screen G2 instead of the screen G1. In the example illustrated in FIG. 10, it is necessary to power off the image forming apparatus 100 for replacement of the fixing unit 40, and the fixing unit 40 has been specified by the specifying section 151 as a target component requiring maintenance.

As illustrated in FIG. 10, the display 52 displays the notification a1 to prompt browsing of a web page on which maintenance information is posted, the access information b, and the notification a2 indicating that the image forming apparatus 100 needs to be powered off for replacement of the fixing unit 40. The access information b includes the QR code b1 and the QR code b2.

The notification a2 enables an operator who performs maintenance to know that the image forming apparatus 100 needs to be powered off for replacement of the fixing unit 40. The notification a1 and the notification a2 enable the operator who performs maintenance to know that the operator can view the maintenance information on the external terminal 500 that the operator carries, even when the image forming apparatus 100 is powered off.

### Modification Example 2

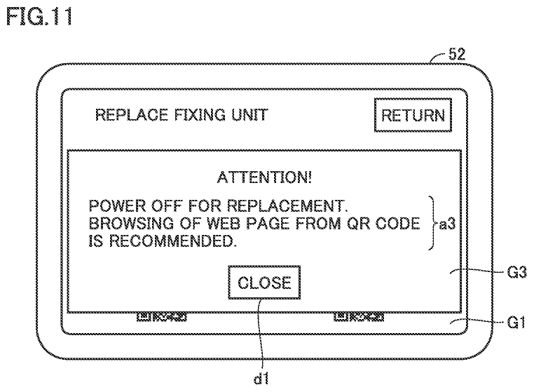

FIG. 11 is a diagram showing Modification Example 2 of the screen displayed on the display 52 of the image forming apparatus 100. When a target component requiring maintenance is specified by the specifying section 151, the display 52 may display only the screen G1 (see FIG. 5), regardless of whether it is necessary to power off the image forming apparatus 100 for maintenance of the target component. However, when the target component requiring maintenance is specified by the specifying section 151 and the image forming apparatus 100 needs to be powered off for maintenance of the target component, the display 52 may further display a screen G3 to overlap a part of the screen G1. In the example illustrated in FIG. 11, the image forming apparatus 100 needs to be powered off for replacement of the fixing unit 40, and the fixing unit 40 has been specified by the specifying section 151 as a target component requiring maintenance.

As illustrated in FIG. 11, the screen G3 includes a notification a3 to prompt browsing of a web page on which maintenance information is posted, and a button d1. The notification a3 further indicates that the image forming apparatus 100 needs to be powered off for replacement of the fixing unit 40. When the button d1 is pressed, the screen G3 disappears and the entire screen G1 becomes visible.

The notification a3 enables an operator who performs maintenance to know that the image forming apparatus 100 needs to be powered off for replacement of the fixing unit 40. The notification a1 and the notification a3 in the screen G1 enable the operator who performs maintenance to know that the operator can view maintenance information on the external terminal 500 that the operator carries, even when the image forming apparatus 100 is powered off.

### Modification Example 3

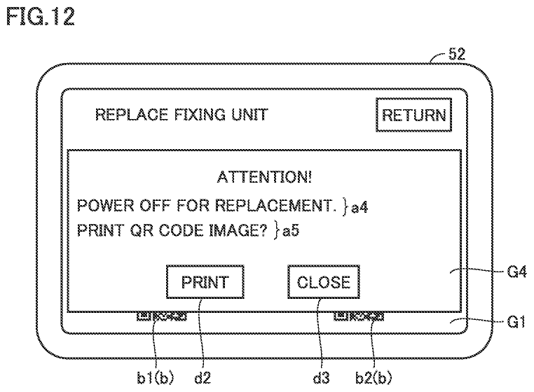

FIG. 12 is a diagram showing Modification Example 3 of the screen displayed on the display 52 of the image forming apparatus 100. When a target component requiring maintenance is specified by the specifying section 151, the display 52 may display only the screen G1 (see FIG. 5), regardless of whether it is necessary to power off the image forming apparatus 100 for maintenance of the target component. However, when the target component requiring maintenance is specified by the specifying section 151 and the image forming apparatus 100 needs to be powered off for maintenance of the target component, the display 52 may further display a screen G4 to overlap a part of the screen G1. In the example illustrated in FIG. 12, the image forming apparatus 100 needs to be powered off for replacement of the fixing unit 40, and the fixing unit 40 has been specified by the specifying section 151 as a target component requiring maintenance.

As illustrated in FIG. 12, the screen G4 includes a notification a4, a notification a5, a button d2, and a button d3. The notification a4 indicates that the image forming apparatus 100 needs to be powered off for replacement of the fixing unit 40.

When the button d2 is pressed, the printer 30 prints the access information b on a sheet in a single color or multiple colors depending on the remaining amount of toner. More specifically, when the remaining amount of each of yellow toner, magenta toner, cyan toner, and black toner is a predetermined value or more, the printer 30 prints the QR code b1 and the QR code b2 on a sheet in multiple colors. When the remaining amount of at least one of the yellow toner, the magenta toner, the cyan toner, and the black toner is less than the predetermined value, the printer 30 prints the QR code b1 and the QR code b2 on a sheet in a single color by using the toner of which remaining amount is the predetermined value or more.

When the button d3 is pressed, the screen G4 disappears and the entire screen G1 becomes visible.

The notification a4 enables an operator who performs maintenance to know that the image forming apparatus 100 needs to be powered off for replacement of the fixing unit 40. The notification a1 and the notification a4 in the screen G1 enable the operator who performs maintenance to know that the operator can view maintenance information on the external terminal 500 that the operator carries, even when the image forming apparatus 100 is powered off. The notification a5 enables the operator who performs maintenance to know that the access information b can be printed.

Note that when it is necessary to power off the image forming apparatus 100 for maintenance of a target component, the display 52 may display only the screen G1 without displaying the screen G4, and the printer 30 may print the access information b on a sheet in a single color or multiple colors depending on the remaining amount of toner.

### Modification Example 4

The speaker 60 may emit a warning sound, when the image forming apparatus 100 needs to be powered off for maintenance of a target component and at least one of the notification a1, the notification a2, the notification a3, the notification a4, and the notification a5 is displayed on the display 52.

### Modification Example 5

When the image forming apparatus 100 needs to be powered off for maintenance of a target component, the display 52 may adjust the brightness of the screen G1, G2 on which the notification a1 is displayed. In one example, when the image forming apparatus 100 needs to be powered off for maintenance of a target component, the display 52 may cause the screen G1, G2 on which the notification a1 is displayed to blink.

When the image forming apparatus 100 needs to be powered off for maintenance of a target component, the display 52 may adjust the brightness of the screen G3. In one example, when the image forming apparatus 100 needs to be powered off for maintenance of a target component, the display 52 may cause the screen G3 to blink.

When the image forming apparatus 100 needs to be powered off for maintenance of a target component, the display 52 may adjust the brightness of the screen G4. In one example, when the image forming apparatus 100 needs to be powered off for maintenance of a target component, the display 52 may cause the screen G4 to blink.

### Modification Example 6

While the image forming apparatus 100 forms an image on a sheet using toner, the “image forming apparatus” in the present disclosure may form an image on a sheet using ink.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising a hardware processor, wherein
the hardware processor specifies a target component requiring maintenance, among one or more components of the image forming apparatus,
the image forming apparatus further comprises a display that displays access information for accessing maintenance information on the target component, and
the access information is information readable by an external terminal different from the image forming apparatus.

2. The image forming apparatus according to claim 1, wherein
the maintenance information includes one or more pieces of sub-information, and
the access information includes a two-dimensional code corresponding to respective one of the one or more pieces of sub-information.

3. The image forming apparatus according to claim 2, wherein the two-dimensional code represents a uniform resource locator (URL) of a web page on which the sub-information included in the maintenance information and corresponding to the two-dimensional code is posted.

4. The image forming apparatus according to claim 2, wherein
the one or more pieces of sub-information include a plurality of pieces of sub-information, and
the plurality of pieces of sub-information include sub-information in a document format and sub-information in a video format.

5. The image forming apparatus according to claim 3, wherein the display further displays a notification to prompt browsing of the web page.

6. The image forming apparatus according to claim 5, further comprising a speaker, wherein
when the image forming apparatus needs to be powered off for maintenance of the target component and the notification is displayed, the speaker emits a warning sound.

7. The image forming apparatus according to claim 5, wherein when the image forming apparatus needs to be powered off for maintenance of the target component, the display adjusts brightness of a screen on which the notification is displayed.

8. The image forming apparatus according to claim 5, further comprising a printer, wherein
when the image forming apparatus needs to be powered off for maintenance of the target component, the printer prints the access information on a sheet.

9. The image forming apparatus according to claim 8, wherein the printer prints the access information on the sheet in a single color or multiple colors depending on a remaining amount of toner.

10. The image forming apparatus according to claim 1, wherein the hardware processor acquires new access information from a management server and updates the access information to the new access information.

11. A providing system comprising the image forming apparatus and the management server according to claim 10, wherein
the management server transmits the new access information to the image forming apparatus, based on apparatus information on the image forming apparatus, and
the apparatus information includes at least one of identifying information on the image forming apparatus and identifying information on the one or more components.

12. A providing method for providing maintenance information on an image forming apparatus, the providing method comprising:
specifying a target component requiring maintenance, among one or more components of the image forming apparatus; and
displaying access information for accessing the maintenance information on the target component, wherein
the access information is information readable by an external terminal different from the image forming apparatus.

13. The providing method according to claim 12, wherein
the maintenance information includes one or more pieces of sub-information, and
the access information includes a two-dimensional code corresponding to respective one of the one or more pieces of sub-information.

14. The providing method according to claim 13, wherein the two-dimensional code represents a uniform resource locator (URL) of a web page on which the sub-information included in the maintenance information and corresponding to the two-dimensional code is posted.

15. The providing method according to claim 13, wherein
the one or more pieces of sub-information include a plurality of pieces of sub-information, and
the plurality of pieces of sub-information include sub-information in a document format and sub-information in a video format.

16. The providing method according to claim 14, further comprising displaying a notification to prompt browsing of the web page.

17. The providing method according to claim 16, further comprising emitting a warning sound when the image forming apparatus needs to be powered off for maintenance of the target component and the notification is displayed.

18. The providing method according to claim 16, further comprising adjusting brightness of a screen on which the notification is displayed, when the image forming apparatus needs to be powered off for maintenance of the target component.

19. The providing method according to claim 16, further comprising printing the access information on a sheet, when the image forming apparatus needs to be powered off for maintenance of the target component.

20. A non-transitory computer-readable recording medium storing a program that causes a computer to perform a providing method for providing maintenance information on an image forming apparatus, the providing method comprising:
specifying a target component requiring maintenance, among one or more components of the image forming apparatus; and
displaying access information for accessing the maintenance information on the target component, wherein
the access information is information readable by an external terminal different from the image forming apparatus.
